(19) United States
(12) Patent Application Publication
(10) Pub. No.: US 2018/0114296 A1
(43) Pub. Date: Apr. 26, 2018

(54) SYSTEMS AND METHODS FOR IMAGE ENHANCEMENT

(71) Applicant: QUALCOMM Incorporated, San Diego, CA (US)

(72) Inventors: Shang-Chih Chuang, New Taipei (TW); Xianbiao Shu, San Diego, CA (US); Xiaoyun Jiang, San Diego, CA (US); Tao Ma, San Diego, CA (US); Chih-Chi Cheng, Santa Clara, CA (US)

(21) Appl. No.: 15/331,159

(22) Filed: Oct. 21, 2016

(51) Int. Cl. G06T 5/00; G06T 5/10; G06T 7/00; G06T 11/60

(52) U.S. Cl. CPC G06T 5/002; G06T 5/10; G06T 7/0085; G06T 2207/20021; G06T 2207/20221; G06T 2207/20192; G06T 11/60

(57) ABSTRACT

A method performed by an electronic device is described. The method includes obtaining an input image. The input image includes image noise. The method also includes removing the image noise from the input image to produce a noise-removed image. The method further includes avoiding enhancing the image noise by performing edge detection on the noise-removed image to produce edge information. The method additionally includes producing a processed image based on the input image and the edge information.

### FIELD OF DISCLOSURE

The present disclosure relates generally to electronic devices. More specifically, the present disclosure relates to systems and methods for determining image enhancement.

### BACKGROUND

Some electronic devices (e.g., cameras, video camcorders, digital cameras, cellular phones, smart phones, computers, televisions, automobiles, personal cameras, action cameras, surveillance cameras, mounted cameras, connected cameras, robots, drones, smart applications, healthcare equipment, set-top boxes, etc.) capture and/or utilize images. For example, a smartphone may capture and/or process still and/or video images. Processing images may demand a relatively large amount of time, memory, and energy resources. The resources demanded may vary in accordance with the complexity of the processing.

It may be difficult to provide high quality image processing, particularly in an efficient manner. For example, some image processing may help to improve some aspects of image quality, but may worsen other aspects. Moreover, high quality image processing may constrain resources, particularly on some platforms. As can be observed from this discussion, systems and methods that improve image processing may be beneficial.

### SUMMARY

A method performed by an electronic device is described. The method includes obtaining an input image. The input image includes image noise. The method also includes removing the image noise from the input image to produce a noise-removed image. The method further includes avoiding enhancing the image noise by performing edge detection on the noise-removed image to produce edge information. The method additionally includes producing a processed image based on the input image and the edge information.

The method may include blending the input image with the noise-removed image to produce a blended image. The method may also include adding the edge information to the blended image to produce the processed image. The noise-removed image may not include added detail.

Removing the image noise may include performing frequency-domain noise reduction block processing based on the input image. Performing frequency-domain noise reduction block processing may include skipping one or more pixels per cycle. Performing frequency-domain noise reduction block processing may include aggregating a subset of pixels from a block to an image frame in accordance with an aggregation mask. Performing frequency-domain noise reduction block processing may include avoiding writing whole blocks of image data by writing a sub-block from registers to an image frame for a block of image data.

An electronic device is also described. The electronic device includes a noise reducer configured to remove image noise from an input image to produce a noise-removed image. The electronic device also includes an edge detector coupled to the noise reducer. The edge detector is configured to avoid enhancing the image noise by performing edge detection on the noise-removed image to produce edge information. The electronic device further includes an edge adder coupled to the edge detector. The edge adder is configured to produce a processed image based on the input image and the edge information.

A computer-program product is also described. The computer-program product includes a non-transitory computer-readable medium with instructions. The instructions include code for causing an electronic device to obtain an input image. The input image includes image noise. The instructions also include code for causing the electronic device to remove the image noise from the input image to produce a noise-removed image. The instructions further include code for causing the electronic device to avoid enhancing the image noise by performing edge detection on the noise-removed image to produce edge information. The instructions additionally include code for causing the electronic device to produce a processed image based on the input image and the edge information.

### BRIEF DESCRIPTION OF THE DRAWINGS

FIG. 1 is a block diagram illustrating one example of an electronic device in which systems and methods for enhancing an image may be implemented;

FIG. 2 is a flow diagram illustrating one configuration of a method for enhancing an image;

FIG. 3 is a flow diagram illustrating another configuration of a method for enhancing an image;

FIG. 4 is a block diagram illustrating an approach for noise reduction and edge enhancement;

FIG. 5 is a block diagram illustrating one example of a hybrid noise reduction architecture;

FIG. 6 is a block diagram illustrating one example of a noise reducer;

FIG. 7 is a graph illustrating one example of tuning by amplitude for noise reduction;

FIG. 8 is a block diagram illustrating one example of an edge detector;

FIG. 9 is a block diagram illustrating an example of frequency-domain noise reduction;

FIG. 10 is a block diagram illustrating an example of frequency-domain noise reduction block processing with pixel skipping;

FIG. 11 is a diagram illustrating one example of an aggregation mask;

FIG. 12 is a diagram illustrating an example of an aggregation buffer;

FIG. 13 is a flow diagram illustrating one configuration of a method 1300 for performing frequency-domain noise reduction block processing; and

FIG. 14 illustrates certain components that may be included within an electronic device configured to implement various configurations of the systems and methods disclosed herein.

### DETAILED DESCRIPTION

Some configurations of the systems and methods disclosed herein may relate to image enhancement. For example, some configurations of the systems and methods disclosed herein may relate to a hybrid noise reduction architecture.

Some image signal processor (ISP) pipelines perform edge detection after a noise reduction block, which may be used in commercialized products. After tuning the tradeoff between noise and details in the noise reduction (NR) block, there may be some remaining noise in images. Detecting edges on noisy images may lead to misdetection and enhancement of this kind of noise. To avoid this issue, noise reduction may be separated into (A) noise reduction without preserving strong noise/weak details and (B) detail blending. Edge detection may be performed on de-noised images, which may enable enhancing strong edges without enhancing strong noise.

Some approaches to spatial domain noise reduction may detect pixel variance with a given fixed-size kernel. These approaches may regard small variances as noise, and may reduce them. However, since the pixel variance in a weak texture area may be small, these approaches cannot distinguish a weak texture from noise. In the frequency domain, each frequency band (which may be referred to as alternating current or alternating component (AC), for example) may present a unique frequency that may be seen as a unique repeating texture. Texture regions may be detected and preserved by frequency-domain analysis.

In some configurations of the systems and methods disclosed herein, a hybrid architecture may detect edges in de-noised images, which may enable enhancing strong edges without enhancing strong noises. The edges may be detected and have a smooth appearance. Details may be added back after edge detection and the resulting images may appear more natural. The amplitude value of each frequency band may be analyzed and classified to accurately suppress smaller amplitudes (e.g., noise) without damaging edges/textures. In some configurations, the noise reduction may include spatial domain de-noising and the hybrid architecture may still provide the same benefits.

Some configurations of the systems and methods disclosed herein may relate to efficient approaches for frequency-domain noise reduction. Redundant frequency-domain noise reduction (e.g., discrete cosine transform (DCT), discrete Fourier transform (DFT), fast Fourier transform (FFT), wavelet transform, block matching and 3D filtering (BM3D), etc.) may be beneficial, corresponding hardware implementation may be expensive. For example, the throughput may be proportional to the block size, and thus computational workload may be significant. This may lead to significant cost in terms of hardware area, memory access rate, and/or power consumption.

Some configurations of the systems and methods disclosed herein may provide efficient approaches for redundant frequency-domain noise reduction. Some of these approaches may include pixel skipping (e.g., block skipping), aggregation masking, and/or aggregation buffering (e.g., separate horizontal/vertical aggregation, sub-block writing, etc.). Some configurations of the systems and methods disclosed herein may reduce the hardware cost and power consumption without a significant impact to the image (e.g., noise reduction) quality. These features may be beneficial, particularly for mobile camera platforms.

Some benefits of some configurations of the systems and methods disclosed herein may include one or more of the following. Edge detection may be performed on noise-removed images (e.g., de-noised images), which may enable enhancing strong edges without enhancing strong noises. Details may be added back after edge detection and may have a more natural appearance. By analyzing the magnitude of frequency band amplitudes (e.g., ACs), even the pixel variance in a weak texture region is small, relatively high magnitude(s) could be observed in one or several frequency bands. When suppressing smaller amplitudes, random noise may be accurately removed but edges/textures may be preserved. Noise reduction may be spatial domain noise reduction in some configurations. Some configurations of the systems and methods disclosed herein may enable redundant frequency-domain noise reduction (e.g., DCT, FFT, Wavelet, BM3D, etc.) to be implemented in hardware. For example, hardware implementation of redundant frequency-domain noise reduction may be costly to implement in hardware without the some configurations systems and methods disclosed herein. A more efficient hardware implementation may be realized with pixel skipping, aggregation masking, and/or aggregation buffering. One or more of these techniques may significantly reduce the hardware area, cost, and/or power consumption, without a significant impact on the image quality. This may enable redundant frequency-domain noise reduction to be more easily implemented on mobile platforms (e.g., mobile chip sets).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

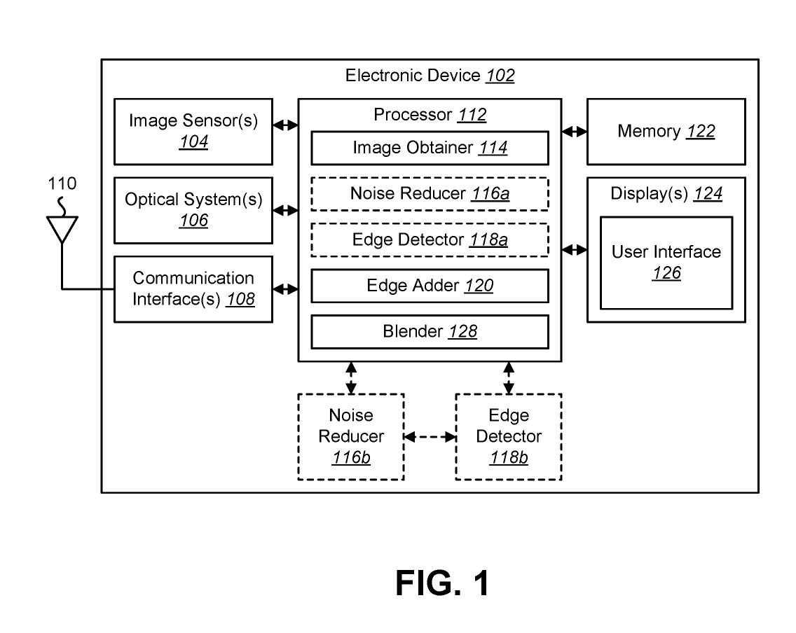

FIG. 1 is a block diagram illustrating one example of an electronic device 102 in which systems and methods for enhancing an image may be implemented. Examples of the electronic device 102 include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, appliances, etc. The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may perform one or more of the functions, procedures, methods, steps, etc., described in connection with one or more of FIGS. 1-3 and 5-14. Additionally or alternatively, the electronic device 102 may include one or more of the structures described in connection with one or more of FIGS. 1-3 and 5-14.

In some configurations, the electronic device 102 may include one or more processors 112, a memory 122, one or more displays 124, one or more image sensors 104, one or more optical systems 106, and/or one or more communication interfaces 108. The processor 112 may be coupled to (e.g., in electronic communication with) the memory 122, display 124, image sensor(s) 104, optical system(s) 106, and/or communication interface(s) 108. It should be noted that one or more of the elements of the electronic device 102 described in connection with FIG. 1 (e.g., image sensor(s) 104, optical system(s) 106, communication interface(s) 108, display(s) 124, etc.) may be optional and/or may not be included (e.g., implemented) in the electronic device 102 in some configurations.

The processor 112 may be a general-purpose single- or multi-chip microprocessor (e.g., an ARM), a special-purpose microprocessor (e.g., a digital signal processor (DSP), an image signal processor (ISP)), a microcontroller, a programmable gate array, dedicated hardware, etc. The processor 112 may be referred to as a central processing unit (CPU) in some configurations. Although just a single processor 112 is shown in the electronic device 102, in an alternative configuration, a combination of processors (e.g., an image signal processor (ISP) and an application processor, an Advanced Reduced Instruction Set Computing (RISC) machine (ARM) and a digital signal processor (DSP), etc.) could be used. The processor 112 may be configured to implement one or more of the methods disclosed herein. The processor 112 may include and/or implement an image obtainer 114, a noise reducer 116a, an edge detector 118a, a blender 128, and/or an edge adder 120 in some configurations.

It should be noted that in some configurations, the noise reducer 116b may not be included in and/or implemented by the processor 112. For example, the noise reducer 116b may be implemented separately (e.g., in a separate chip, separate circuitry, etc.) from the processor 112. Additionally or alternatively, it should be noted that in some configurations, the edge detector 118b may not be included in and/or implemented by the processor 112. For example, the edge detector 118b may be implemented separately (e.g., in a separate chip, separate circuitry, etc.) from the processor 112. When implemented separately, the noise reducer 116b and/or the edge detector 118b may be in electronic communication with the processor 112, the memory 122, with each other, and/or with one or more other elements. When a generic numeric label (e.g., 116 instead of 116a or 116b, or 118 instead of 118a or 118b) is used, this may be meant to refer to the element being implemented on the processor 112, separate from the processor 112, or a combination where corresponding functionality is implemented between both the processor 112 and a separate element. It should be noted that one or more other elements (e.g., the image obtainer 114, the blender 128, and/or the edge adder 120) may additionally or alternatively be implemented separately from the processor 112 in some configurations.

The memory 122 may be any electronic component capable of storing electronic information. For example, the memory 122 may be implemented as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 122 may store instructions and/or data. The processor 112 may access (e.g., read from and/or write to) the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112 and/or various pieces of data may be loaded onto the processor 112. Examples of instructions and/or data that may be stored by the memory 122 may include image data, image obtainer 114 instructions, noise reducer 116 instructions, edge detector 118 instructions, blender 128 instructions, and/or edge adder 120 instructions, etc.

The communication interface(s) 108 may enable the electronic device 102 to communicate with one or more other electronic devices. For example, the communication interface(s) 108 may provide one or more interfaces for wired and/or wireless communications. In some configurations, the communication interface(s) 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication.

In some configurations, multiple communication interfaces 108 may be implemented and/or utilized. For example, one communication interface 108 may be a cellular (e.g., 3G, Long Term Evolution (LTE), CDMA, etc.) interface, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information (e.g., image information, motion vector information, etc.) to and/or receive information from another device (e.g., a vehicle, a smart phone, a camera, a display, a remote server, etc.).

The electronic device 102 (e.g., image obtainer 114) may obtain one or more images (e.g., digital images, image frames, frames, video, etc.). For example, the electronic device 102 may include the image sensor(s) 104 and the optical system(s) 106 (e.g., lenses) that focus images of scene(s) and/or object(s) that are located within the field of view of the optical system 106 onto the image sensor 104. The optical system(s) 106 may be coupled to and/or controlled by the processor 112 in some configurations. A camera (e.g., a visual spectrum camera or otherwise) may include at least one image sensor and at least one optical system. Accordingly, the electronic device 102 may be one or more cameras and/or may include one or more cameras in some implementations. In some configurations, the image sensor(s) 104 may capture the one or more images (e.g., image frames, video, still images, burst mode images, stereoscopic images, etc.).

Additionally or alternatively, the electronic device 102 may request and/or receive the one or more images from another device (e.g., one or more external cameras coupled to the electronic device 102, a network server, traffic camera(s), drop camera(s), vehicle camera(s), web camera(s), etc.). In some configurations, the electronic device 102 may request and/or receive the one or more images via the communication interface 108. For example, the electronic device 102 may or may not include camera(s) (e.g., image sensor(s) 104 and/or optical system(s) 106) and may receive images from one or more remote device(s) (e.g., one or more networked devices, one or more removable memory devices, etc.). One or more of the images (e.g., image frames) may include one or more scene(s) and/or one or more object(s).

In some configurations, the electronic device 102 may include an image data buffer (not shown). The image data buffer may be included in the memory 122 in some configurations. The image data buffer may buffer (e.g., store) image data from the image sensor(s) 104 and/or external camera(s). The buffered image data may be provided to the processor 112. In some configurations, the same image buffer or a different buffer (e.g., an output image buffer, frame buffer, etc.) may store processed image data.

The display(s) 124 may be integrated into the electronic device 102 and/or may be coupled to the electronic device 102. Examples of the display(s) 124 include liquid crystal display (LCD) screens, light emitting display (LED) screens, organic light emitting display (OLED) screens, plasma screens, cathode ray tube (CRT) screens, etc. In some implementations, the electronic device 102 may be a smartphone with an integrated display. In another example, the electronic device 102 may be coupled to one or more remote displays 124 and/or to one or more remote devices that include one or more displays 124.

In some configurations, the electronic device 102 may include a camera software application. When the camera application is running, images of objects that are located within the field of view of the optical system(s) 106 may be captured by the image sensor(s) 104. The images that are being captured by the image sensor(s) 104 may be presented on the display 124. For example, one or more images may be sent to the display(s) 124 for viewing by a user. In some configurations, these images may be played back from the memory 122, which may include image data of an earlier captured scene. The one or more images obtained by the electronic device 102 may be one or more video frames and/or one or more still images. In some configurations, the display(s) 124 may present one or more enhanced images (e.g., noise-reduced images, edge enhanced images, etc.) resulting from one or more of the operations described herein.

In some configurations, the electronic device 102 may present a user interface 126 on the display 124. For example, the user interface 126 may enable a user to interact with the electronic device 102. In some configurations, the user interface 126 may enable a user to input a command. For example, the user interface 126 may receive a touch, a mouse click, a gesture, and/or some other indication that indicates a command to enhance an image and/or one or more image enhancement settings. In some configurations, the display 124 may be a touch display (e.g., a touchscreen display). For example, a touch display may detect the location of a touch input. The touch input may indicate the command to enhance an image and/or may indicate one or more image enhancement settings. It should be noted that some configurations of the systems and methods disclosed herein may be performed automatically, without receiving user input.

The electronic device 102 (e.g., processor 112) may optionally be coupled to, be part of (e.g., be integrated into), include and/or implement one or more kinds of devices. For example, the electronic device 102 may be implemented in a drone or a vehicle equipped with cameras. In another example, the electronic device 102 (e.g., processor 112) may be implemented in an action camera.

The processor 112 may include and/or implement an image obtainer 114. One or more images (e.g., image frames, video, burst shots, etc.) may be provided to the image obtainer 114. For example, the image obtainer 114 may obtain image frames from one or more image sensors 104. For instance, the image obtainer 114 may receive image data from one or more image sensors 104 and/or from one or more external cameras. As described above, the image(s) may be captured from the image sensor(s) 104 included in the electronic device 102 or may be captured from one or more remote camera(s).

In some configurations, the image obtainer 114 may request and/or receive one or more images (e.g., image frames, etc.). For example, the image obtainer 114 may request and/or receive one or more images from a remote device (e.g., external camera(s), remote server, remote electronic device, etc.) via the communication interface 108. The images obtained from the cameras may be enhanced by the electronic device 102 in some configurations.

The processor 112 may include and/or implement a noise reducer 116a in some configurations. Additionally or alternatively, the noise reducer 116b may be implemented separately from the processor 112. For example, the noise reducer 116b may be implemented in a chip separate from the processor 112.

The noise reducer 116 may reduce (e.g., reduce and/or remove) noise from one or more images. In some configurations, the noise reducer 116 may perform frequency-domain noise reduction. For example, the noise reducer 116 may convert an image into the frequency domain (using DCT, DFT, FFT, wavelet transform, etc., for example). The noise reducer 116 may then perform amplitude filtering on the image. For example, the amplitude filtering may include thresholding the frequency-domain image based on amplitude. Amplitudes within one or more ranges (e.g., below a first threshold, between a first and second threshold, etc.) may be regarded as noise (e.g., random noise or weak noise) and may be removed. Amplitudes within one or more ranges (e.g., above a top threshold) may be regarded as an edge or texture. The edges or textures may be preserved and/or enhanced. In some approaches, amplitudes within a range may be regarded as possibly strong noise or weak textures. In some approaches, these amplitudes may be removed. In other approaches, these amplitudes may be preserved. In other approaches, these amplitudes may be preserved at a level (e.g., reduced but preserved).

In some configurations, the noise reducer 116 may perform frequency-domain noise reduction block processing. The frequency-domain noise reduction block processing may be based on an image (e.g., an input image). In some configurations, the frequency-domain noise reduction block processing may include skipping one or more pixels per cycle. Additionally or alternatively, performing frequency-domain noise reduction block processing may include aggregating a subset of pixels from a block to an image frame (e.g., an output image frame) in accordance with an aggregation mask. Additionally or alternatively, performing frequency-domain noise reduction block processing may include aggregation buffering. For example aggregation buffering may avoid writing whole blocks of image data by writing a sub-block from registers to an image frame (e.g., frame buffer) for one or more blocks of the input image.

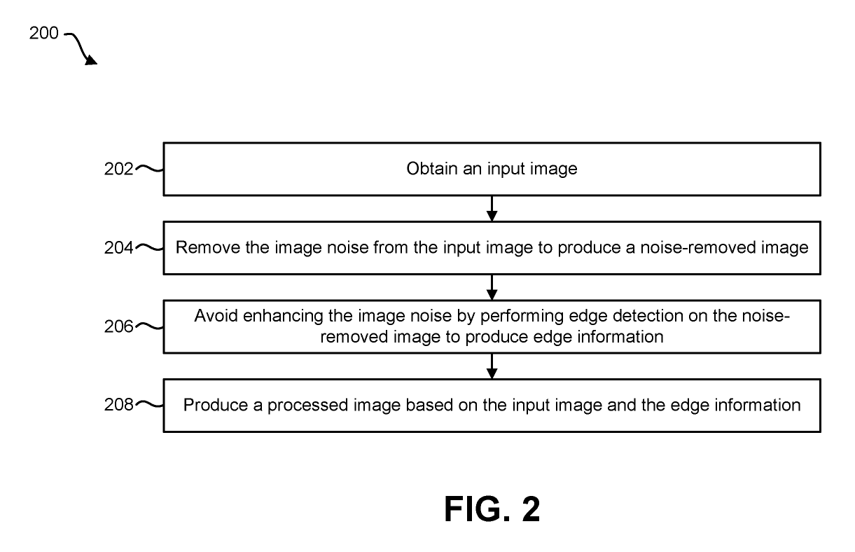

More details regarding some approaches for noise reduction are given in connection with one or more of FIGS. 2-3, 5-7, and 9-13. Removing (or reducing, in some approaches) noise from an image (e.g., input image) may produce a noise-removed image. In some configurations, the noise reducer 116 may additionally or alternatively perform spatial-domain noise reduction.

The processor 112 may include and/or implement an edge detector 118a. Alternatively, the edge detector 118b may be implemented separately from the processor 112. For example, the edge detector 118b may be implemented in a chip separate from the processor 112 (e.g., in separate hardware). The edge detector 118 may detect one or more edges in an image. For instance, the edge detector 118 may detect the location of one or more edges in an image. Examples of edges may include lines, borders, edges between objects, edges between objects and background, etc., in an image. In some configurations, the edge detector 118 may perform high-pass filtering, noise thresholding, and/or halo control to detect the one or more edges. Performing edge detection may produce edge information. The edge information may indicate the location of one or more edges in an image. More details regarding some approaches for edge detection are given in connection with one or more of FIGS. 2-3, 5, and 8.

In some configurations, the edge detector 118 may perform edge detection on a noise removed image. For example, the edge detector 118 may obtain (e.g., request, receive, etc.) a noise-removed image from the noise reducer 116. Performing edge detection on a noise-removed image may avoid enhancing image noise. For example, because image noise has been removed from an image, performing edge detection on the noise-removed image may avoid detecting image noise as an edge. Therefore, edge enhancement may not enhance image noise.

The processor 112 may include and/or implement a blender 128. The blender 128 may blend an image (e.g., input image) with the noise-removed image to produce a blended image. For example, the blender 128 may combine the input image with the noise-removed image. This may add weak details back to the noise-removed image that had been removed and/or may add some image noise back to the noise-removed image. In some configurations, the blending procedure may be accomplished in accordance with the formula out=Weightₙₒᵢₛₑ×image_{orig}+(1.0−weightₙₒᵢₛₑ)×image_{afterNR}, where out is the blender 128 output, weightₙₒᵢₛₑ is a is a weight for the original image (e.g., noisy image), image_{orig} is the original image (e.g., input image), and image_{afterNR} is the noise-removed image.

The processor 112 may include and/or implement an edge adder 120. The edge adder 120 may produce a processed image based on the input image and the edge information. For example, the edge adder 120 may add the edge information to the blended image. Adding the edge information to the blended image may enhance the edges in the blended image. Adding the edge information to the blended image may produce a processed image (e.g., an output image). In some configurations, the edges may be detected with a high-pass filter and then added to the output image (e.g., the blended image).

It should be noted that one or more of the elements or components of the electronic device 102 may be combined and/or divided. For example, one or more of the image obtainer 114, the noise reducer 116, the edge detector 118, the edge adder 120, and/or the blender 128 may be combined. Additionally or alternatively, one or more of the image obtainer 114, the noise reducer 116, the edge detector 118, the edge adder 120, and/or the blender 128 may be divided into elements or components that perform a subset of the operations thereof.

It should be noted that one or more of the elements (e.g., image obtainer 114, noise reducer 116, edge detector 118, edge adder 120, blender 128, etc.) may be coupled. For example, one or more of the elements may be coupled with an electrical or electronic connection. The term “couple” and variations thereof may indicate a direct or indirect connection. For example a first element may be coupled to a second element with or without one or more intervening elements or components. In some cases, one or more of the arrows in the block diagrams may represent one or more couplings.

FIG. 2 is a flow diagram illustrating one configuration of a method 200 for enhancing an image. The method 200 may be performed by an electronic device (e.g., the electronic device 102 described in connection with FIG. 1).

The electronic device 102 may obtain 202 an input image. This may be accomplished as described in connection with FIG. 1. For example, the electronic device 102 may capture one or more images and/or may receive one or more images from one or more remote devices and/or from removable memory.

The electronic device 102 may remove 204 the image noise from the input image to produce a noise-removed image. This may be accomplished as described in connection with one or more of FIGS. 1, 3, 5-7, and 9-13. For example, the electronic device 102 may perform frequency-domain noise reduction and/or spatial-domain noise reduction to reduce and/or remove image noise from the input image. In frequency-domain noise reduction, for instance, the electronic device 102 may perform a frequency-domain transform on the input image, may perform amplitude filtering on the frequency-domain image, and/or may perform an inverse frequency-domain transform on the filtered image. In some configurations, removing 204 the image noise from the input image may include skipping one or more pixels, aggregation, and/or aggregation buffering.

The electronic device 102 may avoid enhancing 206 the image noise by performing edge detection on the noise-removed image to produce edge information. This may be accomplished as described in connection with one or more of FIGS. 1, 3, 5, and 8. For example, the electronic device 102 may perform high-pass filtering, noise thresholding, and/or halo control on the noise-removed image to produce edge information.

The electronic device 102 may produce 208 a processed image based on the input image and the edge information. This may be accomplished as described in connection with one or more of FIGS. 1,3, and 5. For example, the electronic device 102 may enhance the input image based on the edge information to produce a processed image. In another example, the electronic device 102 may blend the input image with the noise-removed image to produce a blended image. The electronic device 102 may add the edge information to the blended image to produce the processed image.

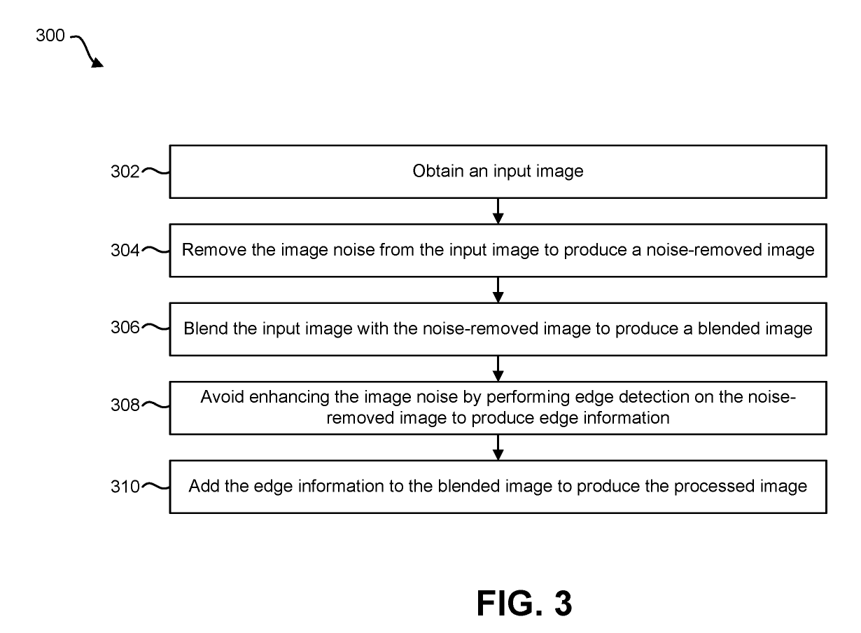

FIG. 3 is a flow diagram illustrating another configuration of a method 300 for enhancing an image. The method 300 may be performed by an electronic device (e.g., the electronic device 102 described in connection with FIG. 1).

The electronic device 102 may obtain 302 an input image. This may be accomplished as described in connection with one or more of FIGS. 1-2.

The electronic device 102 may remove 304 the image noise from the input image to produce a noise-removed image. This may be accomplished as described in connection with one or more of FIGS. 1-2,5-7, and 9-13.

The electronic device 102 may blend 306 the input image with the noise-removed image to produce a blended image. This may be accomplished as described in connection with one or more of FIGS. 1-2. For example, the electronic device 102 may add detail (e.g., weak detail) and/or noise from the input image into the noise-removed image.

The electronic device 102 may avoid enhancing 308 the image noise by performing edge detection on the noise-removed image to produce edge information. This may be accomplished as described in connection with one or more of FIGS. 1-2, 5, and 8.

The electronic device 102 may add 310 the edge information to the blended image to produce the processed image. This may be accomplished as described in connection with one or more of FIGS. 1-2 and 5.

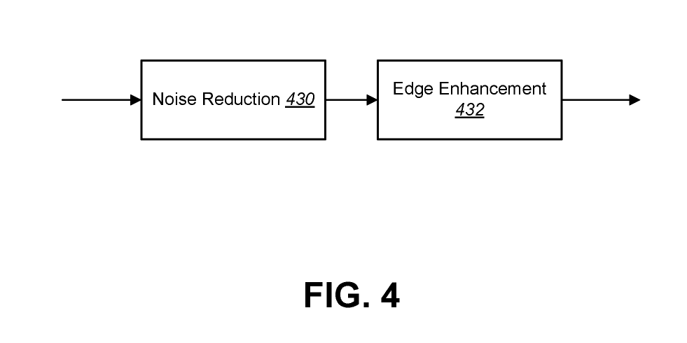

FIG. 4 is a block diagram illustrating an approach for noise reduction 430 and edge enhancement 432. In particular, FIG. 4 illustrates an example of a noise reduction architecture. This approach may include noise reduction 430 and edge enhancement 432. In this approach, an ISP pipeline may perform edge detection after performing noise reduction 430. This approach may be used in some commercialized products. In this approach, the purpose of noise reduction 430 is to reduce noise and keep details. The presents a tradeoff between noise and details. In this approach, the purpose of edge enhancement 432 is to enhance edges and details. This presents a tradeoff between edge and artifacts.

The approach described in connection with FIG. 4 may lead to some problems. Usually after tuning the tradeoff between noise and details in noise reduction 430 (e.g., in a noise reduction block), some noise may remain in the noise-reduced images. Detecting edges in noisy images may lead to misdetection and enhancement of these kinds of noise (e.g., strong noise). Accordingly, the edge enhancement 432 output may include image noise that has been enhanced due to performing edge detection and enhancement on an image with remaining noise.

Some configurations of the systems and methods disclosed herein may avoid and/or solve this problem by performing edge detection on a noise-removed image. Accordingly, performing edge detection and enhancement on a noise-removed image may (largely or completely) avoid enhancing noise through edge detection and/or enhancement. Additionally or alternatively, some original detail may be blended with the noise-removed image to preserve some detail (e.g., weak detail). In particular, some configurations of the systems and methods disclosed herein may utilize noise reduction (e.g., removal) that may avoid the tradeoff between preserving detail and removing noise. For example, more aggressive noise reduction may be performed in order to (largely or completely) remove image noise. This may allow edge detection to be performed on a cleaner image, thereby avoiding detecting noise as an edge. Additionally or alternatively, original detail may be preserved through blending. Accordingly, detail may be preserved and edge enhancement may be performed without enhancing image noise.

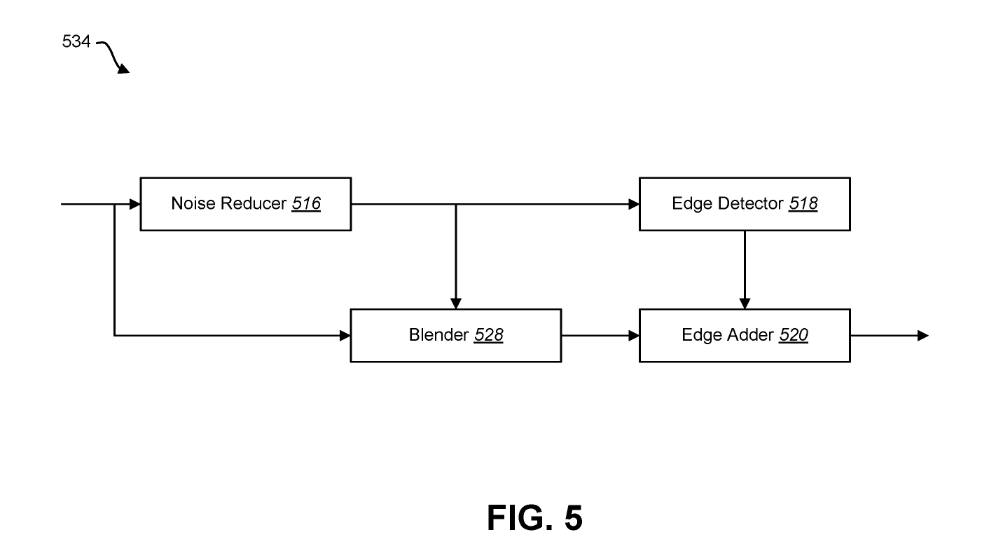

FIG. 5 is a block diagram illustrating one example of a hybrid noise reduction architecture 534. The hybrid noise reduction architecture 534 may be implemented in some configurations of the systems and methods disclosed herein. In this example, the hybrid noise reduction architecture 534 includes a noise reducer 516, a blender 528, an edge detector 518, and an edge adder 520. The noise reducer 516, the blender 528, the edge detector 518, and the edge adder 520 may be examples of corresponding elements described in connection with FIG. 1. FIG. 5 provides some detail on design and tuning targets for noise reduction, edge detection, blending, and edge adding.

In some configurations, the hybrid noise reduction (e.g., de-noising and enhancement) architecture 534 may be viewed as separating a noise reduction function into noise reduction and blending. Accordingly, the noise reducer 516 and the blender 528 may perform separate functions. Additionally or alternatively, the hybrid noise reduction architecture 534 may be viewed as separating an edge enhancement function into edge detection and edge adding. Accordingly, the edge detector 518 and the edge adder 520 may perform separate functions.

An input image may be provided to the noise reducer 516. A design target of the noise reducer 516 may be to preserve texture/edges and remove unnatural noise. A tuning target of the noise reducer 516 may be to balance between details and unnatural noise that might be detected by edge detection. The noise reducer 516 may produce a noise-removed image. In some configurations, the noise-removed image may not include added detail and/or enhanced edges. Additionally or alternatively, the noise-removed image itself may not be a blended image. The noise-removed image may be provided to the blender 528 and to the edge detector 518.

The edge detector 518 may perform edge detection on the noise-removed (e.g., noise-free) image. A design target of the edge detector 518 may be to detect one or more edges in the noise-removed signal. A tuning target of the edge detector 518 may be to balance between edge strength and artifacts caused by unnatural noise. The edge detector 518 may produce edge information (e.g., one or more edges). The edge information may be provided to the edge adder 520.

As illustrated in FIG. 5, the blender 528 may blend the input image and the noise-removed image. The blender 528 may produce a blended image. A design target of the blender 528 may be to add removed weak details and natural noises back to the noise-removed image. In some cases, some noise may be added to clean edge and texture. A tuning target for the blender may be to balance between weak details and natural noises and noise on the edge and texture.

The edge adder 520 may perform edge adding after blending. A design target of the edge adder 520 may be to add edge information (e.g., one or more edges) back to the blended image. The hybrid noise reduction architecture 534 may enable enhancing strong edges without enhancing strong noises. The edge adder 520 may produce a processed image (e.g., an output image). In some configurations, blending and/or edge adding may not be performed on a difference image.

In some approaches, blending and edge adding may be performed as follows. Blending may be designed to add the input image (e.g., partial original or noisy signal) into the noise-removed image. For example, blending and edge adding may be performed in accordance with the following formula Pₒᵤₜ=(weightₙₒᵢₛₑ×P_{beforeNR}+(1.0−weightₙₒᵢₛₑ)×P_{afterNR})+edge, where weightₙₒᵢₛₑ is a percentage of detail blending, P_{beforeNR} is the input image, P_{imageNR} is the noise-removed image, edge is the edge information, and Pₒᵤₜ is the processed image (e.g., output image). The percentage of detail blending weightₙₒᵢₛₑ may be controlled in accordance with one or more factors. Examples of the factors may include level, chrominance, and skin color.

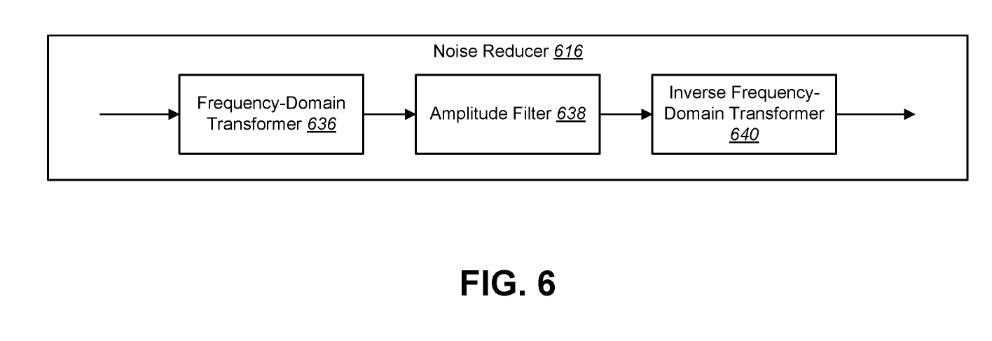

FIG. 6 is a block diagram illustrating one example of a noise reducer 616. The noise reducer 616 may be an example of one or more of the noise reducers 116, 516 described herein. The noise reducer 616 may include a frequency-domain transformer 636, an amplitude filter 638, and an inverse frequency-domain transformer 640. The noise reducer 616 may receive an image (e.g., an input image). The image (e.g., one or more N×N pixel blocks) may be provided to the frequency-domain transformer 636.

The frequency-domain transformer 636 may transform the image (e.g., input image) into the frequency domain. For example, the frequency-domain transformer 636 may transform each N×N block (e.g., N×N Y block) to the frequency domain with a frequency-domain transform such as FFT, DCT, or wavelet transform, etc. The resulting frequency-domain image (e.g., blocks of frequency-domain data) may be provided to the amplitude filter 638.

The amplitude filter 638 may filter the frequency-domain image (e.g., blocks of frequency-domain data) based on amplitude. For example, noise reduction may be performed by suppressing amplitude of one or more frequency bands. If the amplitude of the data is small enough (e.g., less than a threshold), the data may be regarded as noise. The amplitude filter 638 may suppress (e.g., largely suppress) the absolute value of data with a small enough amplitude (that is less than a threshold, for example). If the amplitude of the data is larger (e.g., greater than a threshold), the data may be regarded as strong noise or weak texture. The amplitude filter 638 may preserve (at a certain level, for example) the value of data with an amplitude that is larger (e.g., greater than a threshold). The amplitude-filtered data (e.g., image) may be provided to the inverse frequency-domain transformer 640.

The inverse frequency-domain transformer 640 may transform the amplitude-filtered data (e.g., image) to the spatial domain. For example, the inverse frequency-domain transformer may inversely transform the N×N block to the spatial domain (using inverse FFT (IFFT), inverse DCT (IDCT), inverse wavelet transform, etc., for example). This may produce an N×N block (e.g., N×N Y block) in the spatial domain.

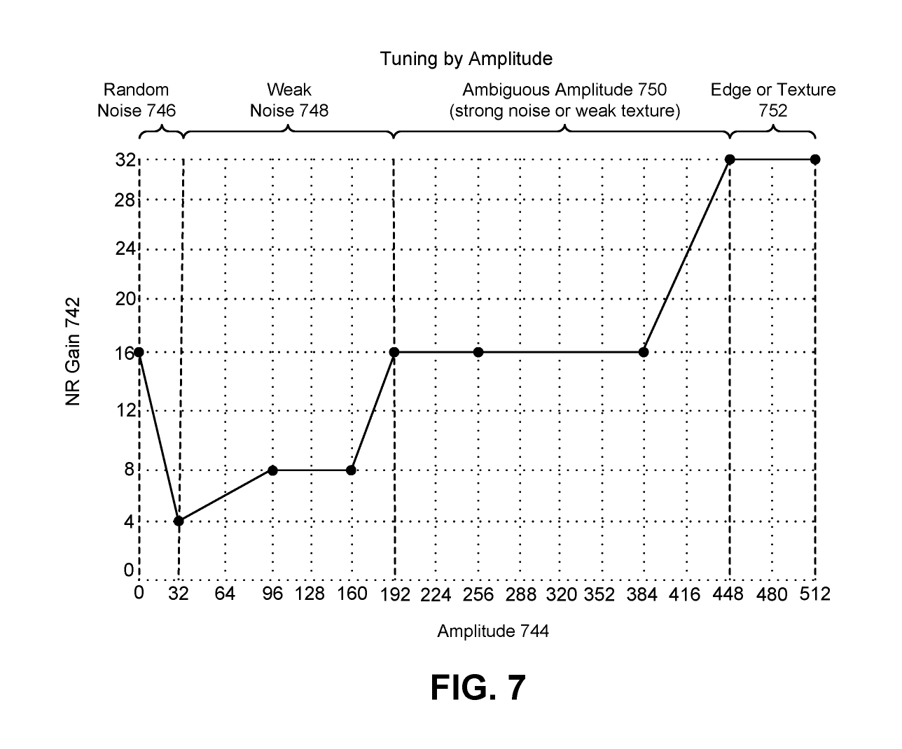

FIG. 7 is a graph illustrating one example of tuning by amplitude for noise reduction. The graph is illustrated in noise reduction (NR) gain 742 corresponding to amplitude 744. In some configurations, one or more of the noise reducers 116, 516, 616 described herein may function in accordance with the graph illustrated in FIG. 7.

In the DCT domain, each coefficient may present a combination of vertical and horizontal repeating textures (over DCT frequencies, for example). After transforming to the frequency domain, each frequency band amplitude (which may be referred to as AC) may represent the strength of edge or texture 752, weak texture or strong noise 750, weak noise 748, or random noise 746.

The plot in the graph in FIG. 7 may illustrate an example of a filtering curve. Amplitude filtering may be carried out in accordance with the filtering curve based on the amplitude 744 of DCT frequencies. For example, amplitude filtering may be performed in accordance with the formula AC′=AC×Gain_{NR}, where AC is the frequency band amplitude, Gain_{NR} is the noise reduction gain, and AC′ is the filtered frequency band amplitude. As illustrated in FIG. 7, each amplitude region (e.g., random noise 746, weak noise 748, ambiguous amplitude 750, and/or edge or texture 752) may be filtered in accordance with the amplitude filtering curve. Examples of amplitude filtering are given in accordance with Tables (1), (2), and (3), where Table (1) is an example of an edge, Table (2) is an example of texture, and Table (3) is an example of a flat region. Table (1) illustrates an example of preserving a horizontal low frequency edge.

TABLE 1
Edge
8 × 8 DCT before filtering

| | | | | | | | |
|---|---|---|---|---|---|---|---|
| 5654 | 75 | 35 | 59 | 26 | 36 | 121 | 12 |
| 448 | 67 | 117 | 51 | 46 | 14 | 21 | 1 |
| 199 | 160 | 97 | 38 | 65 | 8 | 25 | 14 |
| 176 | 77 | 32 | 10 | 57 | 10 | 46 | 10 |
| 156 | 120 | 6 | 8 | 56 | 20 | 4 | 0 |
| 149 | 11 | 26 | 28 | 45 | 19 | 0 | 12 |
| 55 | 204 | 71 | 7 | 4 | 76 | 61 | 21 |
| 22 | 24 | 155 | 89 | 66 | 6 | 4 | 4 |

8 × 8 DCT after filtering

| | | | | | | | |
|---|---|---|---|---|---|---|---|
| 5654 | 13 | 3 | 8 | 3 | 3 | 29 | 3 |
| 448 | 11 | 28 | 6 | 6 | 3 | 3 | 0 |
| 95 | 48 | 23 | 3 | 11 | 2 | 3 | 3 |
| 74 | 15 | 3 | 2 | 7 | 2 | 6 | 2 |
| 41 | 29 | 1 | 2 | 7 | 4 | 0 | 0 |
| 35 | 2 | 3 | 3 | 4 | 3 | 0 | 3 |
| 7 | 98 | 12 | 1 | 0 | 15 | 10 | 3 |
| 3 | 3 | 41 | 18 | 11 | 1 | 0 | 0 |

Table (2) illustrates an example of preserving a vertical middle frequency edge.

TABLE 2
Texture
8 × 8 DCT before filtering

| | | | | | | | |
|---|---|---|---|---|---|---|---|
| 6106 | 44 | 203 | 85 | 280 | 314 | 92 | 17 |
| 63 | 32 | 123 | 10 | 46 | 46 | 86 | 52 |
| 113 | 19 | 17 | 109 | 94 | 49 | 176 | 66 |
| 66 | 36 | 26 | 36 | 36 | 68 | 29 | 40 |
| 114 | 7 | 115 | 22 | 8 | 11 | 55 | 1 |
| 82 | 89 | 17 | 4 | 0 | 3 | 52 | 26 |
| 28 | 26 | 7 | 7 | 25 | 5 | 12 | 25 |
| 24 | 40 | 4 | 15 | 24 | 13 | 1 | 12 |

8 × 8 DCT after filtering

| | | | | | | | |
|---|---|---|---|---|---|---|---|
| 6106 | 5 | 88 | 18 | 280 | 314 | 20 | 3 |
| 9 | 3 | 26 | 2 | 6 | 6 | 18 | 7 |
| 24 | 3 | 3 | 23 | 20 | 6 | 77 | 10 |
| 10 | 3 | 2 | 3 | 3 | 10 | 2 | 4 |
| 24 | 1 | 24 | 3 | 2 | 2 | 7 | 0 |
| 14 | 19 | 3 | 0 | 0 | 0 | 7 | 2 |
| 2 | 2 | 1 | 1 | 2 | 1 | 3 | 2 |
| 2 | 4 | 0 | 3 | 2 | 3 | 0 | 3 |

Table (3) illustrates an example of suppressing all amplitudes.

TABLE 3
Flat Region
8 × 8 DCT before filtering

| | | | | | | | |
|---|---|---|---|---|---|---|---|
| 7236 | 31 | 57 | 12 | 66 | 62 | 33 | 85 |
| 70 | 83 | 206 | 130 | 8 | 27 | 58 | 12 |
| 113 | 109 | 23 | 45 | 20 | 55 | 46 | 31 |
| 83 | 7 | 72 | 65 | 56 | 32 | 9 | 67 |
| 12 | 70 | 91 | 95 | 134 | 29 | 0 | 2 |
| 88 | 28 | 70 | 0 | 17 | 60 | 21 | 3 |
| 22 | 58 | 76 | 38 | 22 | 4 | 12 | 25 |
| 52 | 7 | 5 | 42 | 31 | 6 | 8 | 15 |

8 × 8 DCT after filtering

| | | | | | | | |
|---|---|---|---|---|---|---|---|
| 7236 | 1 | 5 | 2 | 7 | 7 | 2 | 11 |
| 8 | 11 | 67 | 21 | 1 | 2 | 5 | 2 |
| 18 | 17 | 3 | 3 | 3 | 5 | 4 | 1 |
| 11 | 1 | 8 | 7 | 5 | 2 | 1 | 7 |
| 2 | 8 | 12 | 15 | 21 | 1 | 0 | 0 |
| 12 | 2 | 8 | 0 | 2 | 5 | 2 | 0 |
| 2 | 5 | 10 | 2 | 2 | 0 | 2 | 2 |
| 5 | 1 | 1 | 3 | 1 | 1 | 1 | 2 |

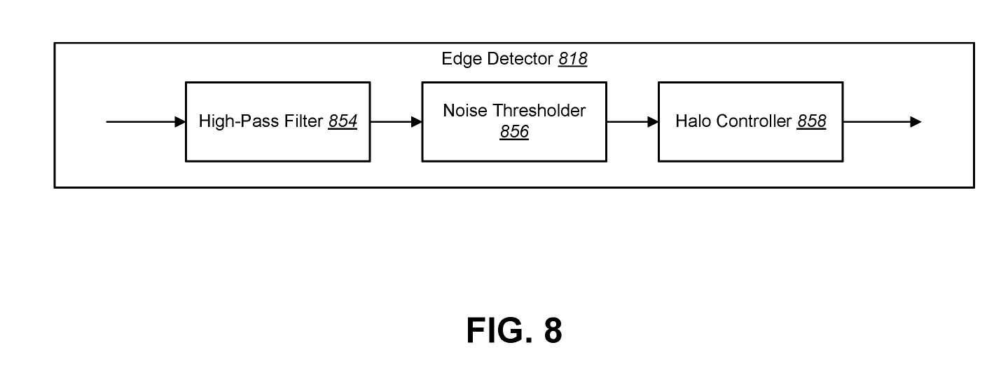

FIG. 8 is a block diagram illustrating one example of an edge detector 818. The edge detector 818 may be an example of one or more of the edge detectors 118, 518 described herein. The edge detector 818 may receive an image (e.g., a noise-removed image). It should be noted that the noise-removed image may include residual noise (e.g., a small amount of noise left after noise reduction) in some cases. Edge detection may be performed on the noise-removed image (e.g., image signal). The edges may be detected and may have a smooth appearance.

The edge detector 818 may include a high-pass filter 854, a noise thresholder 856, and a halo controller 858. The noise-removed image (e.g., one or more N×N pixel blocks) may be provided to the high-pass filter 854. The high-pass filter 854 may perform high-pass filtering on the noise-removed image (e.g., each N×N buffer (e.g., N×N Y buffer)). In some configurations, the high-pass filter 854 may perform high-pass filtering as a general un-sharp masking procedure. The resulting filtered image (e.g., N×N data) may be provided to the noise thresholder 856.

The noise thresholder 856 may perform noise thresholding on the filtered image. Noise thresholding may be used to suppress small mis-detected edges due to remaining noise. The noise-thresholded image may be provided to the halo controller 858.

The halo controller 858 may perform halo control on the noise-thresholded image. For example, halo control may be used to limit the edge strength to prevent overshooting or halo. The halo controller 858 may produce edge information.

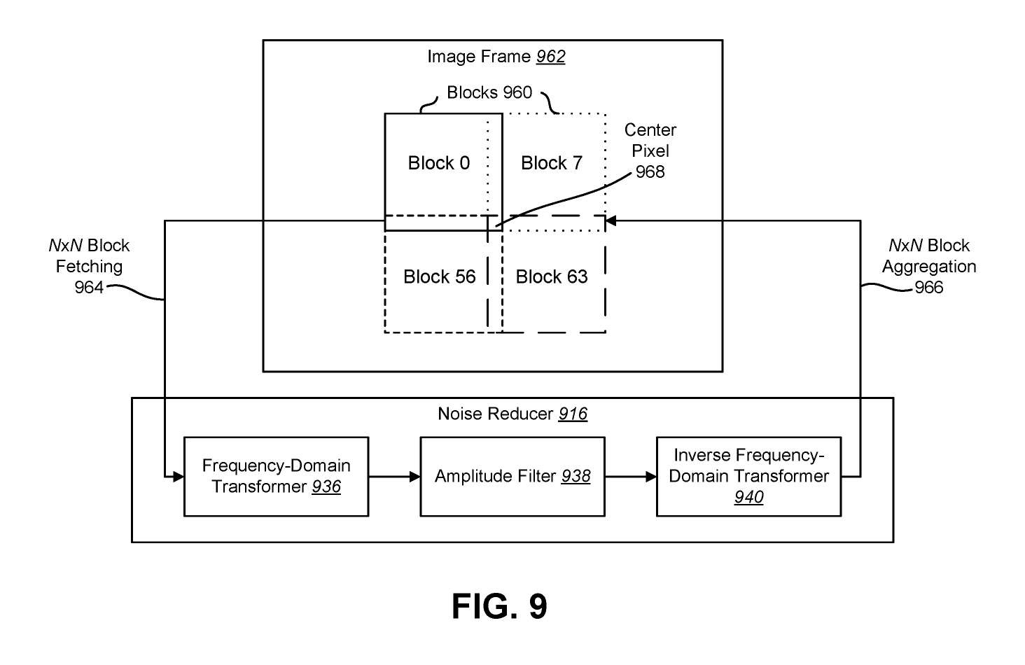

FIG. 9 is a block diagram illustrating an example of frequency-domain noise reduction. In particular, FIG. 9 illustrates an image frame 962 (e.g., an input image) and a noise reducer 916. The noise reducer 916 may be an example of one or more of the noise reducers 116, 516, 616 described herein.

Blocks 960 of the image frame 962 may be fetched to the noise reducer 916. For example, the image frame 962 may be stored in memory (e.g., memory 122, a frame buffer, other memory, etc.). N×N block fetching 964 may be performed to provide an N×N block of the image frame 962 to the noise reducer 916. For example, a processor (e.g., processor 112) and/or the noise reducer 916 may perform block fetching 964. Each fetched N×N block may be transformed to the frequency domain by the frequency-domain transformer 936 (using FFT, DCT, wavelet transform, etc., for example). Each frequency band amplitude (which may be denoted AC) may represent the strength of edges, textures, strong noise, and/or weak noise.

The amplitude filter 938 may perform noise reduction by suppressing one or more frequency band amplitudes based on amplitude (e.g., AC′=AC×Gain_{NR}). This may be accomplished as described in connection with one or more of FIGS. 5-7, for instance. For example, noises (with small amplitude) may be suppressed. Edges or textures (with large amplitude) may be preserved and/or enhanced. The N×N block may be inversely transformed by the inverse frequency-domain transformer 940. Block aggregation (e.g., N×N block aggregation 966) may be performed to aggregate the data to the image frame 962 (e.g., noise-removed image, noise-reduced image, noise reduction output image, frame buffer, memory, etc.). For example, a processor (e.g., processor 112) and/or the noise reducer 916 may perform block aggregation 966. Assuming an 8×8 block (e.g., N=8), an output center pixel 968 may be determined in accordance with the following formula

$$output ( px , py ) = \frac{{\sum }_{i = 0}^{63} {y}_{i} {w}_{i}}{{\sum }_{i = 0}^{63} {w}_{i}} ,$$

where output(px, py) is the output center pixel at horizontal index px and vertical index py, yᵢ is a block with index i, and wᵢ is the weighting of each yᵢ. A higher wᵢ will influence the output more.

The example described in connection with FIG. 9 may present some challenges in hardware design. For example, the approach described in FIG. 9 may require high throughput (e.g., N² pixels per cycle). Assuming N=8, a computational cost per clock cycle may be given as follows. The forward transform may include 16 (e.g., 8+8) one-dimensional (1D) transforms. Amplitude filtering may include 64 multiplications. The inverse transform may include 16 e.g., 8+8) 1D transforms. Aggregation may include 64 read-addition-write operations. This computational cost may lead to expensive hardware area cost, memory access rate, and/or power consumption.

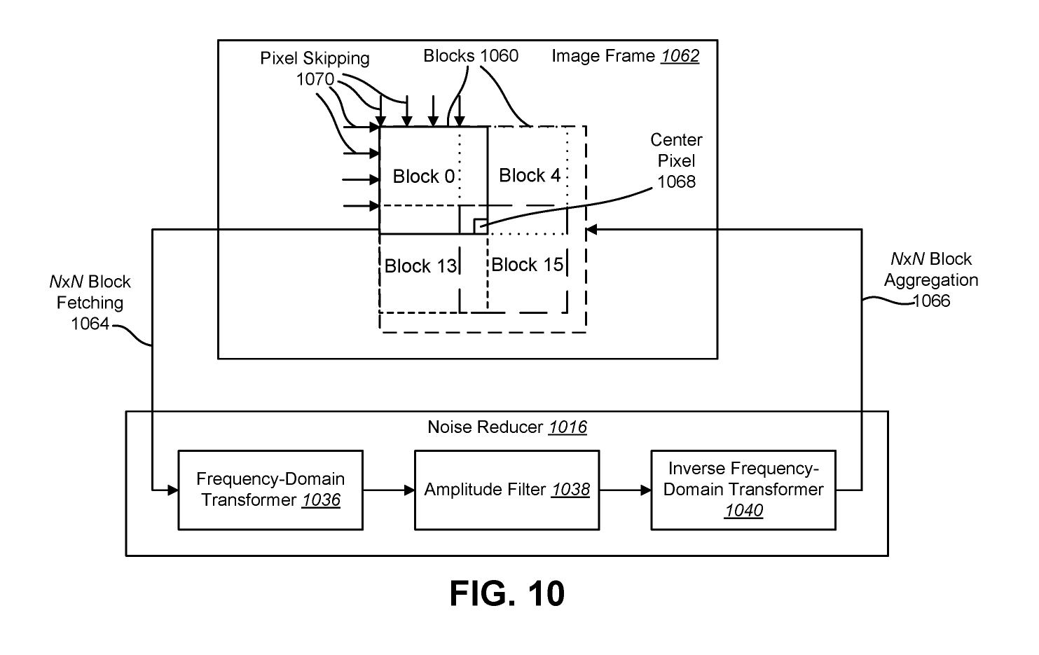

FIG. 10 is a block diagram illustrating an example of frequency-domain noise reduction block processing with pixel skipping 1070. In particular, FIG. 10 illustrates an image frame 1062 (e.g., an input image) and a noise reducer 1016. The noise reducer 1016 may be an example of one or more of the noise reducers 116, 516, 616 described herein.

Blocks 1060 of the image frame 1062 may be fetched to the noise reducer 1016. For example, the image frame 1062 may be stored in memory (e.g., memory 122, a frame buffer, other memory, etc.). N×N block fetching 1064 may be performed to provide an N×N block of the image frame 1062 to the noise reducer 1016. For example, a processor (e.g., processor 112) and/or the noise reducer 1016 may perform block fetching 1064. In some implementations, pixel skipping may be implemented in hardware. For example, the noise reducer 1016 may be implemented in hardware (e.g., in an integrated circuit) and may perform pixel skipping in hardware (and not in software, for instance).

In configurations with pixel skipping, a reduced number of N×N blocks may be fetched and/or processed. Pixel skipping may be configurable (e.g., the number of pixels skipped may be configurable) for block processing. In pixel skipping, N×N block processing may be performed for every (n+1)×(n+1) block, where n denotes the number of skipped pixels.

In the example illustrated in FIG. 10, N=8 and n=1. Accordingly, pixel skipping 1070 may include fetching and/or performing 8×8 block processing for each 2×2 group of pixels. Assuming N=8 and n=1, a computational cost per clock cycle may be given as follows. The forward transform may include 4 (e.g., 2+2) 1D transforms. Amplitude filtering may include 16 multiplications. The inverse transform may include 4 (e.g., 2+2) 1D transforms. Aggregation may include 16 read-addition-write operations. In comparison with the block processing described in connection with FIG. 9, this may significantly reduce (by 75%) hardware area cost, memory access rate, and/or power consumption.

Each fetched N×N block may be transformed to the frequency domain by the frequency-domain transformer 1036 (using FFT, DCT, wavelet transform, etc., for example). Each frequency band amplitude (which may be denoted AC) may represent the strength of edges, textures, strong noise, and/or weak noise.

The amplitude filter 1038 may perform noise reduction by suppressing one or more frequency band amplitudes based on amplitude (e.g., AC′=AC×Gain_{NR}). This may be accomplished as described in connection with one or more of FIGS. 5-7, for instance. The N×N block may be inversely transformed by the inverse frequency-domain transformer 1040. Block aggregation (e.g., N×N block aggregation 1066) may be performed to aggregate the data to the image frame 1062 (e.g., noise-removed image, noise-reduced image, noise reduction output image, frame buffer, output buffer, memory, etc.). For example, a processor (e.g., processor 112) and/or the noise reducer 1016 may perform block aggregation 1066. Assuming an 8×8 block (e.g., N=8), an output center pixel 1068 may be determined in accordance with the processed blocks with pixel skipping.

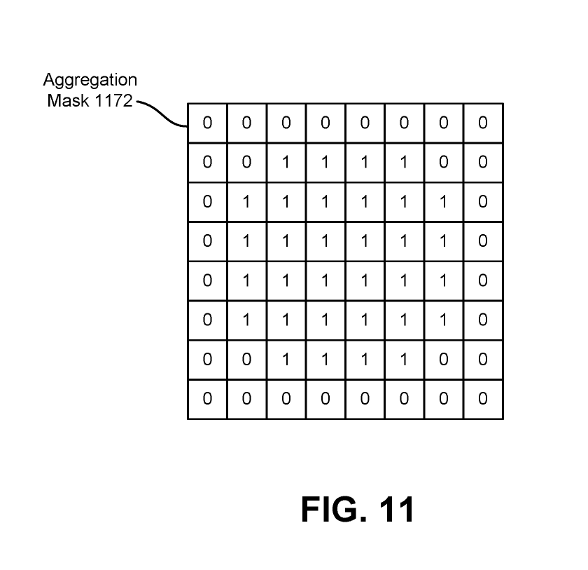

FIG. 11 is a diagram illustrating one example of an aggregation mask 1172. In some configurations of the systems and methods disclosed herein, performing frequency-domain noise reduction block processing may include aggregating a subset of pixels from a block to an image frame (e.g., an output image frame) in accordance with an aggregation mask. For example, configurable aggregation masking may be implemented in accordance with some configurations of the systems and methods disclosed herein. In some implementations, aggregation masking may be implemented in hardware. For example, a noise reducer may be implemented in hardware (e.g., in an integrated circuit) and may perform aggregation masking in hardware (and not in software, for instance).

Aggregating a subset of pixels form a block to an image frame may include selecting only a subset of pixels of a block (e.g., a block of noise-reduced or noise-removed pixel data) to be aggregated to an image frame (e.g., output image frame, frame buffer, memory, output buffer, etc.).

In some approaches, an aggregation mask may indicate the selection of pixels for aggregation. For instance, pixels corresponding to a “1” value in an aggregation mask may be aggregated, while pixels corresponding to a “0” value in the aggregation mask may not be aggregated. The example illustrated in FIG. 11 includes a circular-shaped aggregation mask 1172. The aggregation mask 1172 may select the center 32 pixels in an 8×8 block to be aggregated into the image frame. This may reduce memory access rate and “read-add-write” operations by 50% (in comparison with aggregating all 64 pixels of an 8×8 block). The aggregation mask 1172 may also help improve diagonal edge continuity.

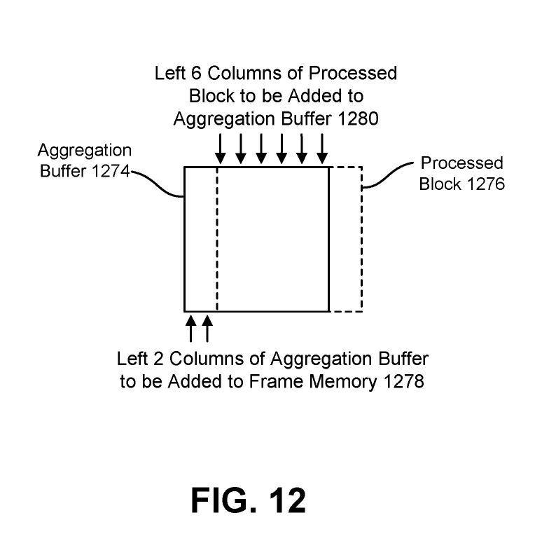

FIG. 12 is a diagram illustrating an example of an aggregation buffer. In some implementations, sub-block writing may be implemented in hardware. For example, a noise reducer may be implemented in hardware (e.g., in an integrated circuit) and may perform sub-block writing in hardware (and not in software, for instance).

In sub-block writing, an aggregation buffer may be utilized. An aggregation buffer may be a set of registers that may be utilized to store a block of processed data. For example, once a block of data is processed, only a sub-block may be written into the aggregation buffer. In the example illustrated in FIG. 12, the aggregation buffer 1274 may store processed pixel data corresponding to an 8×8 set of pixels of an image frame. For instance, an 8×8 aggregation buffer 1274 (e.g., registers) may be utilized to save data for horizontal aggregation. Instead of a full 8×8 block, only a left 8×2 sub-block of data may be aggregated 1278 into frame memory (e.g., to an output buffer, image frame, etc.). When a subsequent processed block 1276 is produced, only the left six columns of the processed block may be added 1280 to the aggregation buffer. This approach may reduce a memory access rate and/or “read-add-write” operations by 75% in comparison with writing an entire block of data per cycle. This may significantly improve the power consumption. It should be noted that the aggregation buffer may be utilized for one or both of horizontal aggregation and vertical aggregation. It should also be noted that different numbers of columns and/or rows may be read and/or written with the aggregation buffer. Additionally or alternatively, the aggregation buffer may be different sizes in different configurations.

It should be noted that pixel skipping, aggregation masking, and/or aggregation buffering (e.g., the techniques described in connection with one or more of FIGS. 10-13) may be performed independently and/or in combination with one or more of the other techniques described herein. For example, pixel skipping, aggregation masking, and/or aggregation buffering may be performed independently of or in combination with a hybrid noise reduction architecture.

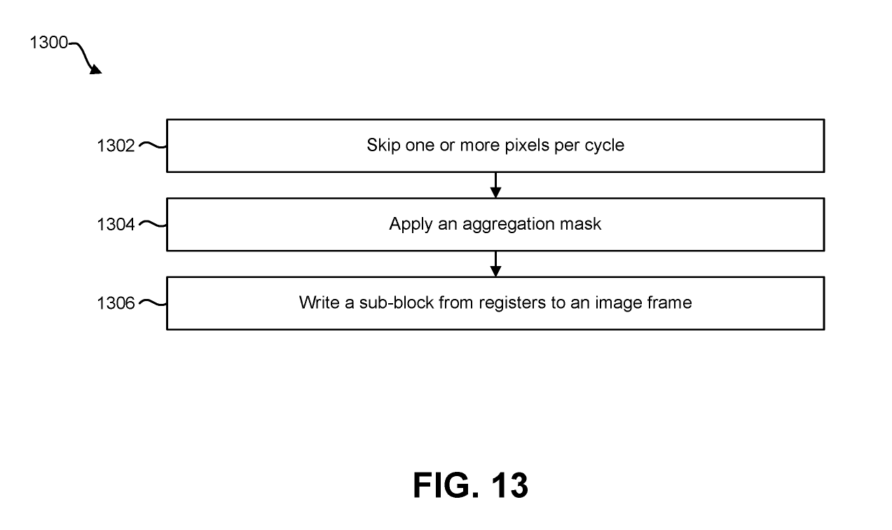

FIG. 13 is a flow diagram illustrating one configuration of a method 1300 for performing frequency-domain noise reduction block processing. The method 1300 may be performed by the electronic device 102 (e.g., processor 112, noise reducer 116, etc.) described in connection with FIG. 1.

The electronic device 102 may obtain (e.g., fetch) one or more blocks of image data. For example, the electronic device 102 may fetch a series of blocks from memory to a noise reducer. The electronic device 102 may optionally skip 1302 one or more pixels per cycle. For example, instead of fetching a block corresponding to every pixel of an image, the electronic device 102 may skip 1302 fetching one or more blocks corresponding to one or more pixels. In some configurations, this may be accomplished as described in connection with FIG. 10.

The electronic device 102 may optionally apply 1304 an aggregation mask. For example, the electronic device 102 may aggregate only a subset of pixels (e.g., noise-reduced pixels, processed pixels, etc.) to an image frame in accordance with an aggregation mask. In some configurations, this may be accomplished as described in connection with FIG. 11. It should be noted that different aggregations masks may be applied (e.g., circular aggregation masks, rectangular aggregations masks, etc.), depending on the configuration.

The electronic device 102 may optionally write 1306 a sub-block from registers to an image frame. For example, the electronic device 102 may write only a sub-block to an aggregation buffer. In some configurations, this may be accomplished as described in connection with FIG. 12. It should be noted that one or more of pixel skipping, aggregation masking, and aggregation buffering may be implemented in accordance with the systems and methods disclosed herein.

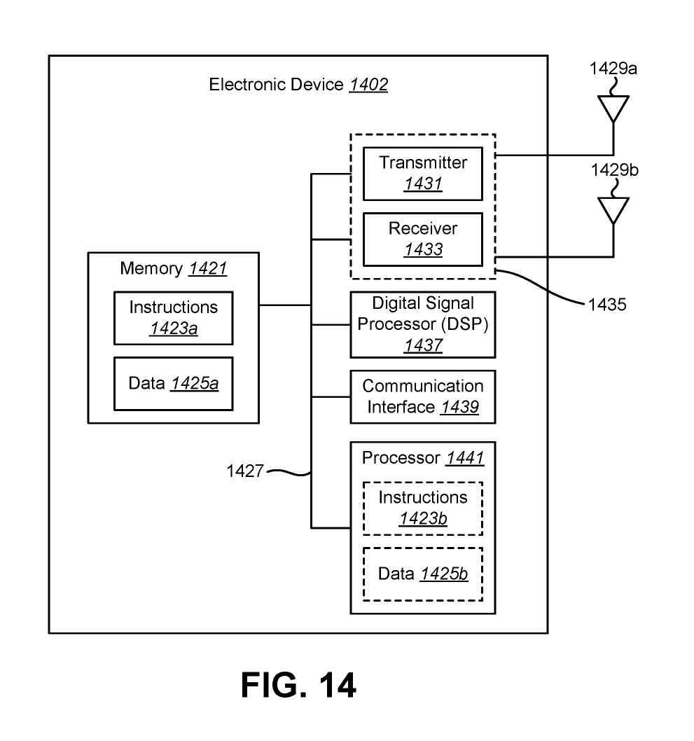

FIG. 14 illustrates certain components that may be included within an electronic device 1402 configured to implement various configurations of the systems and methods disclosed herein. For example, the electronic device 1402 may be implemented with a hybrid architecture and/or may be implemented to perform redundant frequency-domain noise reduction in accordance with one or more configurations of the systems and methods disclosed herein. The electronic device 1402 may be and/or may be included in an access terminal, a mobile station, a user equipment (UE), a smartphone, a digital camera, a video camera, a tablet device, a laptop computer, a vehicle, a drone, an augmented reality device, a virtual reality device, an aircraft, an appliance, a television, etc. The electronic device 1402 may be implemented in accordance with one or more of the electronic devices and/or in accordance with one or more of the components and/or functions described herein (e.g., components and/or functions described in connection with one or more of FIGS. 1 and 5-13).

The electronic device 1402 includes a processor 1441. The processor 1441 may be a general purpose single- or multi-chip microprocessor (e.g., an ARM), a special purpose microprocessor (e.g., a digital signal processor (DSP), an image signal processor (ISP), etc.), a microcontroller, a programmable gate array, etc. The processor 1441 may be referred to as a central processing unit (CPU). Although just a single processor 1441 is shown in the electronic device 1402, in an alternative configuration, a combination of processors (e.g., an ARM and DSP) could be implemented.

The electronic device 1402 also includes memory 1421. The memory 1421 may be any electronic component capable of storing electronic information. The memory 1421 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Data 1425a and instructions 1423a may be stored in the memory 1421. The instructions 1423a may be executable by the processor 1441 to implement one or more of the methods 200, 300, 1300 described herein. Executing the instructions 1423a may involve the use of the data 1425a that is stored in the memory 1421. When the processor 1441 executes the instructions 1423, various portions of the instructions 1423b may be loaded onto the processor 1441, and various pieces of data 1425b may be loaded onto the processor 1441.

The electronic device 1402 may also include a transmitter 1431 and a receiver 1433 to allow transmission and reception of signals to and from the electronic device 1402. The transmitter 1431 and receiver 1433 may be collectively referred to as a transceiver 1435. One or more antennas 1429a-b may be electrically coupled to the transceiver 1435. The electronic device 1402 may also include (not shown) multiple transmitters, multiple receivers, multiple transceivers and/or additional antennas.

The electronic device 1402 may include a digital signal processor (DSP) 1437. The electronic device 1402 may also include a communication interface 1439. The communication interface 1439 may allow and/or enable one or more kinds of input and/or output. For example, the communication interface 1439 may include one or more ports and/or communication devices for linking other devices to the electronic device 1402. In some configurations, the communication interface 1439 may include the transmitter 1431, the receiver 1433, or both (e.g., the transceiver 1435). Additionally or alternatively, the communication interface 1439 may include one or more other interfaces (e.g., touchscreen, keypad, keyboard, microphone, camera, etc.). For example, the communication interface 1439 may enable a user to interact with the electronic device 1402.

The various components of the electronic device 1402 may be coupled together by one or more buses, which may include a power bus, a control signal bus, a status signal bus, a data bus, etc. For the sake of clarity, the various buses are illustrated in FIG. 14 as a bus system 1427.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), synchronous dynamic random access memory (SDRAM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method performed by an electronic device, comprising:
obtaining an input image, wherein the input image includes image noise;
removing the image noise from the input image to produce a noise-removed image;
avoiding enhancing the image noise by performing edge detection on the noise-removed image to produce edge information; and
producing a processed image based on the input image and the edge information.

2. The method of claim 1, further comprising:
blending the input image with the noise-removed image to produce a blended image; and
adding the edge information to the blended image to produce the processed image.

3. The method of claim 1, wherein the noise-removed image does not include added detail.

4. The method of claim 1, wherein removing the image noise comprises performing frequency-domain noise reduction block processing based on the input image.

5. The method of claim 4, wherein performing frequency-domain noise reduction block processing comprises skipping one or more pixels per cycle.

6. The method of claim 4, wherein performing frequency-domain noise reduction block processing comprises aggregating a subset of pixels from a block to an image frame in accordance with an aggregation mask.

7. The method of claim 4, wherein performing frequency-domain noise reduction block processing comprises avoiding writing whole blocks of image data by writing a sub-block from registers to an image frame for a block of image data.

8. An electronic device, comprising:
a noise reducer configured to remove image noise from an input image to produce a noise-removed image;
an edge detector coupled to the noise reducer, wherein the edge detector is configured to avoid enhancing the image noise by performing edge detection on the noise-removed image to produce edge information; and
an edge adder coupled to the edge detector, wherein the edge adder is configured to produce a processed image based on the input image and the edge information.

9. The electronic device of claim 8, further comprising a blender configured to blend the input image with the noise-removed image to produce a blended image, and wherein the edge adder is configured to add the edge information to the blended image to produce the processed image.

10. The electronic device of claim 8, wherein the noise-removed image does not include added detail.

11. The electronic device of claim 8, wherein the noise reducer is configured to remove the image noise by performing frequency-domain noise reduction block processing based on the input image.

12. The electronic device of claim 11, wherein the noise reducer is configured to skip one or more pixels per cycle.

13. The electronic device of claim 11, wherein the noise reducer is configured to perform aggregating a subset of pixels from a block to an image frame in accordance with an aggregation mask.

14. The electronic device of claim 11, wherein the noise reducer is configured to avoid writing whole blocks of image data by writing a sub-block from registers to an image frame for a block of image data.

15. A computer-program product, comprising a non-transitory computer-readable medium having instructions thereon, the instructions comprising:
code for causing an electronic device to obtain an input image, wherein the input image includes image noise;
code for causing the electronic device to remove the image noise from the input image to produce a noise-removed image;
code for causing the electronic device to avoid enhancing the image noise by performing edge detection on the noise-removed image to produce edge information; and
code for causing the electronic device to produce a processed image based on the input image and the edge information.

16. The computer-program product of claim 15, further comprising:
code for causing the electronic device to blend the input image with the noise-removed image to produce a blended image; and
code for causing the electronic device to add the edge information to the blended image to produce the processed image.

17. The computer-program product of claim 15, wherein the code for causing the electronic device to remove the image noise comprises code for causing the electronic device to perform frequency-domain noise reduction block processing based on the input image.

18. The computer-program product of claim 17, wherein the code for causing the electronic device to perform frequency-domain noise reduction block processing comprises code for causing the electronic device to skip one or more pixels per cycle.

19. The computer-program product of claim 17, wherein the code for causing the electronic device to perform frequency-domain noise reduction block processing comprises code for causing the electronic device to aggregate a subset of pixels from a block to an image frame in accordance with an aggregation mask.

20. The computer-program product of claim 17, wherein the code for causing the electronic device to perform frequency-domain noise reduction block processing comprises code for causing the electronic device to avoid writing whole blocks of image data by writing a sub-block from registers to an image frame for a block of image data.
